(19) United States
(12) Patent Application Publication
(10) Pub. No.: US 2021/0407493 A1
(43) Pub. Date: Dec. 30, 2021

(54) Audio Anomaly Detection in a Speech Signal

(71) Applicant: Plantronics, Inc., Santa Cruz, CA (US)

(72) Inventors: Manoj Ramakrishnan, Carmel, CA (US); Nabila Rahman, Cedar Park, TX (US)

(73) Assignee: Plantronics, Inc., Santa Cruz, CA (US)

(21) Appl. No.: 16/917,501

(22) Filed: Jun. 30, 2020

(51) Int. Cl. G10L 15/08; G10L 25/51; G06F 16/65; G06F 16/683; G06K 9/62

(52) U.S. Cl. CPC G10L 15/08; G10L 25/51; G06K 9/6223; G06F 16/683; G06F 16/65

(57) ABSTRACT

Systems and methods for audio anomaly detection in a voice signal are provided. In some embodiments, a system comprises a voice history database storing historic audio metadata of past voice signals acquired during operation of a user audio device; a data clustering processor, connected to the voice history database and configured for cluster analysis of the historic audio metadata into a normal operation cluster and an anomalous operation cluster and to provide a user audio model therefrom; a voice model database, configured to receive and to store the user audio model; and a classification processor, connected with the voice model database. The classification processor may receive current audio metadata of the voice signal from the user audio device; compare the current audio metadata with the user audio model; and determine if the voice signal corresponds to a normal operating mode or an anomalous operating mode of the user audio device.

### FIELD

The present disclosure relates generally to the field of sound processing of voice audio signals. More particularly, the present disclosure relates to determining, if an anomaly exists in a voice signal of a user.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Devices that capture a user's voice are commonly used in everyday life, such as in telecommunication applications. A typical problem for a user is to determine, whether her or his captured voice can be clearly understood on the side of the receiving party. Sometimes, disturbances during transmission, such as artefacts or delays, may result in a lack of transmission quality that make it difficult for the receiving party to easily understand the user. Other typical issues include poor reception of a wireless device, a high level of background noise, or an incorrect microphone placement of, e.g., a headset.

Usually, the user will assume that the quality of the transmission is sufficient and will continue talking until the receiving telecommunication participant responds that the quality is insufficient. This may lead to an inconvenient and annoying back-and-forth between the user and the receiving participant, in particular when the quality varies over time or when multiple receiving parties are involved, e.g., in a conference call.

Thus, an object exists to automatically determine the quality of a voice signal so that insufficient quality can be addressed.

### SUMMARY

The object is solved by the subject matter of the independent claims. The dependent claims and the following description describe various embodiments of the invention.

In general and in one aspect, a system for audio abnormality detection in a voice signal is provided. The system comprises a voice history database, a data clustering processor, a voice model database, and a classification processor. According to the present aspect, the voice history database comprises historic audio metadata of one or more past voice signals, acquired during operation of a user audio device. The data clustering processor is connected to the voice history database and configured for cluster analysis of the historic audio metadata into at least a normal operation cluster and an anomalous operation cluster and to provide a user audio model therefrom. The voice model database is configured to receive and to store the user audio model. Finally, the classification processor is connected with the voice model database and configured to receive current audio metadata of the voice signal from the user audio device, to compare the current audio metadata with the user audio model, and to determine therefrom, if the voice signal corresponds to a normal operating mode or an anomalous operating mode of the user audio device.

In another aspect, a method of audio anomaly detection in a voice signal is provided. The method of the present aspect comprising receiving a user audio model and current audio metadata of the voice signal; comparing the current audio metadata with the user audio model; and to determine therefrom, if the voice signal corresponds to a normal operating mode or an anomalous operating mode of the user audio device.

In another aspect, a method of generating a user audio model for use in a system for audio anomaly detection in a voice signal is provided. The method of the present aspect comprising conducting cluster analysis of historic audio metadata of one or more past voice signals, acquired during operation of a user audio device, into at least a normal operation cluster and an anomalous operation cluster, and generating a user audio model therefrom.

The details of one or more embodiments are set forth in the accompanying drawings and the description below. Other features will be apparent from the description, drawings, and from the claims.

### DESCRIPTION OF DRAWINGS

FIG. 1 shows an embodiment of a system for audio anomaly detection in a voice signal in a schematic view;

FIG. 2 shows a schematic flow diagram of the operation of a data clustering processor of the embodiment of FIG. 1;

FIG. 3 shows a schematic flow diagram of the operation of a classification processor of the embodiment of FIG. 1;

FIGS. 4 and 5 show exemplary diagrams of the result of a clustering, performed by data clustering processor of the embodiment of FIG. 1; and

FIGS. 6 and 7 show exemplary diagrams of the result of clustering, performed by data clustering processor of the embodiment of FIG. 1 on noise level metadata.

### DETAILED DESCRIPTION

Specific embodiments of the invention are here described in detail, below. In the following description of embodiments of the invention, the specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In the following explanation of the present invention according to the embodiments described, the terms “connected to” or “connected with” are used to indicate a data and/or audio (signal) connection between at least two components, devices, units, processors, or modules. Such a connection may be direct between the respective components, devices, units, processors, or modules; or indirect, i.e., over intermediate components, devices, units, processors, or modules. The connection may be permanent or temporary; wireless or conductor based.

For example, a data and/or audio connection may be provided over a direct connection, a bus, or over a network connection, such as a WAN (wide area network), LAN (local area network), PAN (personal area network), BAN (body area network) comprising, e.g., the Internet, Ethernet networks, cellular networks, such as LTE, Bluetooth (classic, smart, or low energy) networks, DECT networks, ZigBee networks, and/or Wi-Fi networks using a suitable communications protocol. In some embodiments, a USB connection, a Bluetooth network connection and/or a DECT connection is used to transmit audio and/or data.

In the following description, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between like-named elements. For example, a first element is distinct from a second element, and the first element may encompass more than one element and succeed (or precede) the second element in an ordering of elements.

In view of the rising use of audio telecommunication in everyday life, such as using (smart) phones, tablets, headsets, and other personal communication devices that allow recording of a user's voice utterances or speech and, e.g., transmitting as a voice signal, the inventors of the instant invention have conceived it would be helpful to be able to determine if the recorded and transmitted user's voice is of insufficient quality automatically and without supervision. A corresponding automatic classification based on heuristics or static logic with a certain predefined sound level however is difficult to realize in view of differences in the dynamics of each speaker and audio device combination. The present invention aims at solving this issue by using past trends in the user's audio data, i.e., historic audio metadata of past or previous voice signals of the user for a determination of current quality of the user's audio data. The collected historic audio metadata allows to efficiently determine automatically, whether a current or present voice signal shows an anomality that may result in poor audio quality and/or a lack of sufficient audibility of the user.

In one aspect, a system for audio anomaly detection in a voice signal is provided. The system comprises a voice history database, a data clustering processor, a voice model database, and a classification processor.

In the present context, the term “voice signal” is understood as an analog or digital representation of audio in time or frequency domain, wherein the voice signal comprises at least one vocal utterance or speech of a user, i.e., the respective user's voice. For example, a voice signal may be a signal, picked up by at least one microphone during an audio communication, an audio call or conference, a video call or conference, a presentation, a panel discussion, a talk, a lecture, or a recording, such as a voice recording for broadcast purposes. The voice signal in some embodiments may comprise a mixture and/or sequence of vocal utterances or speech and other signal components, such as for example background noise.

The voice signal may be acquired during operation of a user audio device, as will be discussed in the following in more detail. For example, the signals described herein may be of pulse code modulated (PCM) type, or any other type of bit stream signal. Each signal may comprise one channel (mono signal), two channels (stereo signal), or more than two channels (multichannel signal). The signal(s) may be compressed or not compressed.

The voice history database may be of any suitable type of database or data storage system and at least comprises historic audio metadata of one or more past/historic voice signals, acquired during operation of the user audio device. In some embodiments, the voice history database is setup on a remote and/or cloud server.

In the context of the present invention, the term ‘audio metadata’ is understood to refer to any metadata of the voice signal, such as in particular, but not limited to: sound pressure, sound intensity, sound power, sound energy, and voice activity. Accordingly, the historic audio metadata may comprise any data that describes one or more parameters of the past voice signals.

In some embodiments, the audio metadata comprises data over time, i.e., a course of the respective parameter. It is noted that while the past voice signals themselves or corresponding audio data are not comprised in the audio metadata to keep the amount of necessary data storage small, in some embodiments, the voice history database may comprise recordings of the past voice signals, i.e., the corresponding voice data itself that can be used to replicate the recorded voice utterances or speech of the user.

A user audio device in the present context is understood as a device that is configured to acquire/capture a user's voice and to provide the voice signal. For example, the user audio device may be one or more of a headset, a desk phone, a computer, video conferencing equipment, or any other personal communication device or audio and/or video endpoint. In some embodiments, the user audio device is a body-worn or head-worn audio device, such as in particular, but not limited to one with a position-adjustable microphone. The microphone of the user audio device may be of any suitable type, such as dynamic, condenser, electret, ribbon, carbon, piezoelectric, fiber optic, laser, or MEMS type. The microphone may be omnidirectional or directional.

In some embodiments, the user audio device is a telecommunication audio device. The user audio device may comprise components such as an analog-to-digital converter, (wireless) interface to connect at least temporarily to the voice history database, processing circuitry to obtain audio metadata, user interface, battery or other power source, etc.

In some embodiments, the system according to the present aspect comprises one or more user audio devices of the same or of different users. Further embodiments of a multi-user or multi-device system are discussed in the following. In some embodiments, the system according to the present aspect is connectable to one or more user audio devices of the same or of different users.

As discussed in the preceding, the system according to the present aspect further comprises the data clustering processor.

The data clustering processor is connected to the voice history database and is configured for cluster analysis of the historic audio metadata into at least a normal operation cluster and an anomalous operation cluster and to provide a user audio model therefrom.

The data clustering processor may be of any suitable type to conduct cluster analysis, such as a microprocessor with suitable programming, wherein cluster analysis is understood herein with its typical meaning in the art, namely grouping a set of objects in such a way that objects in the same group (called a cluster) are more similar (in some sense) to each other than to those in other groups (clusters). For example, the data clustering processor may be configured for hierarchical clustering, distribution-based clustering, density-based clustering, or other suitable clustering algorithms.

In some embodiments, the data clustering processor is configured for cluster analysis using centroid-based clustering, such as in particular, but not limited to K-means clustering. In some embodiments, K-means clustering with k=2 and n observations is used, where n may for example be a number of at least 500. The conduction of K-means clustering with k=2 results in obtaining the normal operation cluster and the anomalous operation cluster.

Once the historic audio metadata is clustered, the resulting data forms a user audio model. The user audio model is then transferred to the voice model database and stored there. The voice model database may be of any suitable type of database or data storage system for storing at least one user audio model.

According to the present aspect, the voice model database is further connected to the classification processor of the system of the present aspect. The classification processor is configured for receiving current audio metadata of the voice signal from the user audio device and to compare the current audio metadata with the user audio model. In other words, current audio metadata is compared with the user audio model that is generated using the historic audio metadata. The current audio metadata may be real-time metadata of a live voice signal or metadata of a past voice signal, such as for example a just completed call to allow determining the call quality of that call for analytical purposes.

In any event, the classification processor is further configured to determine from the current audio metadata, if the corresponding voice signal corresponds to a normal operating mode or an anomalous operating mode of the user audio device. For example, the classification processor may be configured to determine the operating mode by comparing the current audio metadata with the normal operation cluster and the anomalous operation cluster of the user model, such as, e.g., by determining a distance of the current audio metadata to a center or centroid of the respective cluster. In this example, the shortest distance is an indication of which cluster, i.e., the normal operation cluster or the anomalous operation cluster, has the closest relation to the current audio metadata and thus the (current) voice signal. In some embodiments, the classification processor may be configured to determine, if a predefined percentage (threshold) of data points of the current audio metadata in a predefined time period are related to the anomalous operation cluster and in this case, determine, that the voice signal corresponds to the anomalous operating mode. For example, the classification processor may be configured with a ‘running window percentage’ that allows to determine a time frame-based percentage threshold over the course of the voice signal, and thus, e.g., over the course of a voice call. For example, an indication of more than 50% of data points related to the anomalous operation cluster in a given window, such as 10 seconds, may indicate the anomalous operating mode.

In some embodiments, the anomalous operating mode corresponds to one or more of an incorrect placement of a microphone of the user audio device, a defect of the user audio device, and an irregular background noise level, captured by the microphone of the user audio device.

The data clustering processor and the classification processor may be of any suitable type. For example and in some embodiments, the data clustering processor and/or the classification processor may be provided in corresponding dedicated circuitry, which may comprise integrated and/or non-integrated dedicated circuitry. Alternatively and in some embodiments, the data clustering processor and/or the classification processor may be provided using software, stored in a memory of the system, and their respective functionalities is provided when the software is executed on a common or one or more dedicated processing devices, such as a CPU, microcontroller, or DSP.

The system for audio abnormality detection according to the present aspect and in further embodiments certainly may comprise additional components. For example, the system in one exemplary embodiment may comprise additional control circuitry, additional circuitry to process audio, wireless or wired communications interfaces, a central processing unit, one or more housings, and/or a battery.

The determination of whether the current audio metadata corresponds to the normal operating mode or the anomalous operating mode is useful, e.g., to allow a user of the system and the audio device to correct insufficiencies in the voice signal without quickly and without a receiver noticing or mentioning a poor audio quality. For example, an anomalous operating mode may be the result of an incorrect placement of an adjustable microphone, which, once the user is aware of the incorrect placement, is easily correctable. Similarly and in another example, the anomalous operating mode may be the result of too much noise in the user's surroundings, to that once the user is aware of the fact that the noise level is too much, the user may correct by moving to a more silent space. In other embodiments, the determination of whether the audio metadata corresponds to the normal operating mode or the anomalous operating mode may be used to allow a supervisor in a call-center to analyze the audio metadata to improve the workspace, without limitation.

In some embodiments, the classification processor provides an anomalous operation indicator in case the anomalous operating mode is determined. The anomalous operation indicator may in some embodiments be provided by the classification processor to the user audio device and thus, directly to the user. In some embodiments, the anomalous operation indicator is provided to a different device of the user, as, e.g., identified by a common user account. For example, the anomalous operation indicator may be provided to a computer of the user, while a voice call is being conducted using the user's smart phone. In this case, a notification on a screen of the computer may make the user more readily aware of an issue with the audio quality compared to displaying a message on the smart phone that is pressed against the user's ear and thus not visible. The anomalous operation indicator may in some embodiments provide the user with instructions as to how to rectify the poor audio, e.g., by changing the microphone positioning, exchange headsets, or remove background noise.

In some embodiments, the anomalous operation indicator is provided to a central quality management system. The present embodiments may be particularly useful for organizations, such as call-center operators, to allow monitoring the overall audio quality of calls that are conducted by the call center.

In some embodiments, the historic audio metadata and the current audio metadata comprises sound pressure level information. The sound pressure level information may, e.g., be a (general) sound pressure level as determined by the user audio device.

In some embodiments, the historic audio metadata and the current audio metadata comprises sound pressure level information of speech, e.g., the user's speech during use of the user audio device.

In some embodiments, the historic audio metadata and the current audio metadata comprises sound pressure level information of noise, such as for example background noise.

In some embodiments, the historic audio metadata and the current audio metadata comprises a voice activity parameter. The voice activity parameter may be of any suitable type and indicates that the user is currently speaking. For example, the voice activity parameter may be inferred from metadata, which shows a time magnitude (e.g., milliseconds) of the user speaking in a given time period. In some embodiments, the voice activity parameter is used in conjunction with sound pressure level information of speech and/or sound pressure level information of noise to allow determining, if the current sound pressure level is attributable to speech or noise.

In some embodiments, the voice history database is connectable to the user audio device to receive audio metadata. In some embodiments, the voice history database is configured to store the received audio metadata as historic audio metadata for later use. The aforementioned embodiments may allow the voice history database to be setup initially, but also to be updated subsequently, e.g., periodically, according to an external trigger, or whenever the user audio device is used. The aforementioned embodiments may improve the quality of data.

In some embodiments, the current audio metadata of the voice signal from the user audio device is additionally provided to the voice history database to update the historic audio metadata. The present embodiment allows to update the voice history database whenever current audio metadata is generated, e.g., upon every use of the user audio device. In some embodiments, the current audio metadata is provided by the user audio device to the voice history database. In some embodiments, the current audio metadata is provided by classification processor to the voice history database.

In some embodiments, the data clustering processor is configured for repeated cluster analysis of the historic audio metadata. In some embodiments, the data clustering processor is configured to provide an updated user audio model accordingly, which may, e.g., subsequently be stored in the voice model database. The repeated cluster analysis may in corresponding embodiments be conducted periodically, upon a change of the voice history database, according to an external trigger, or whenever the user audio device is used, without limitation.

In some embodiments, the voice history database comprises historic audio metadata of one or more past voice signals, acquired during operation of at least a first user audio device and a second user audio device. The first and second user audio device may be of the same or of different users.

Since in general, every combination of user and user audio device may provide different audio metadata, the voice history database in a multi-user or multi-device application may comprise historic audio metadata for a plurality of user/device combinations. For example, different users may speak with different sound pressure and different pitch, which may influence what is normal for this particular user. Similarly, different user audio devices may capture the user's voice differently due to different microphone types, different internal audio processing, and different microphone placements. For example, an in-line headset microphone arranged at the user's chest during use will capture the voice differently than a headset microphone, provided on a boom and placed in front of the user's mouth during use. In some instances, even the same type and model of user audio device may not provide comparable data since typical user audio devices are not calibrated.

In some embodiments, the data clustering processor is configured for separate cluster analysis of the historic audio metadata of the at least first user audio device and the second user audio device. In some embodiments, a separate user audio model is generated for each of the at least first and second user audio devices, i.e., for each user/device combination. In some embodiments, the user audio models are subsequently stored in the voice model database. In some embodiments, each of the stored user audio models comprises an identifier of the respective user/device combination.

In some embodiments, the system comprises a user account database that is configured to manage a plurality of user and user audio device combinations.

In another aspect, a data clustering processor for use in a system for audio anomaly detection in a voice signal is provided. The data clustering processor is connected to a voice history database having historic audio metadata and the data clustering processor is configured for cluster analysis of the historic audio metadata into at least a normal operation cluster and an anomalous operation cluster and to provide a user audio model therefrom.

In some embodiments, the data clustering processor according to the present aspect is configured according to one or more of the embodiments, discussed in the preceding with respect to the preceding aspect(s). With respect to the terms used and their definitions, reference is made to the preceding aspect(s).

According to another aspect, a classification processor for use in a system for audio anomaly detection in a voice signal is provided. The classification processor is configured to receive a user audio model and current audio metadata of the voice signal from a user audio device; compare the current audio metadata with the user audio model; and to determine therefrom, if the voice signal corresponds to a normal operating mode or an anomalous operating mode of the user audio device.

In some embodiments, the classification processor according to the present aspect is configured according to one or more of the embodiments, discussed in the preceding with respect to the preceding aspect(s). With respect to the terms used and their definitions, reference is made to the preceding aspect(s).

According to another aspect, a method of audio anomaly detection in a voice signal is provided. The method comprises receiving a user audio model and current audio metadata of the voice signal; comparing the current audio metadata with the user audio model; and to determine therefrom, if the voice signal corresponds to a normal operating mode or an anomalous operating mode of the user audio device.

In some embodiments, the method according to the present aspect is configured according to one or more of the embodiments, discussed in the preceding with respect to the preceding aspect(s). With respect to the terms used and their definitions, reference is made to the preceding aspect(s).

According to another aspect, a method of generating a user audio model for use in a system for audio anomaly detection in a voice signal is provided, the method comprising conducting cluster analysis of historic audio metadata of one or more past voice signals, acquired during operation of a user audio device, into at least a normal operation cluster and an anomalous operation cluster, and generating a user audio model therefrom. In some embodiments, the method further comprises storing of the user audio model for later use.

In some embodiments, the method according to the present aspect is configured according to one or more of the embodiments, discussed in the preceding with respect to the preceding aspect(s). With respect to the terms used and their definitions, reference is made to the preceding aspect(s).

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate figures. It is further noted that the figures are schematic and provided for guidance to the skilled reader and are not necessarily drawn to scale. Rather, the various drawing scales, aspect ratios, and numbers of components shown in the figures may be purposely distorted to make certain features or relationships easier to understand.

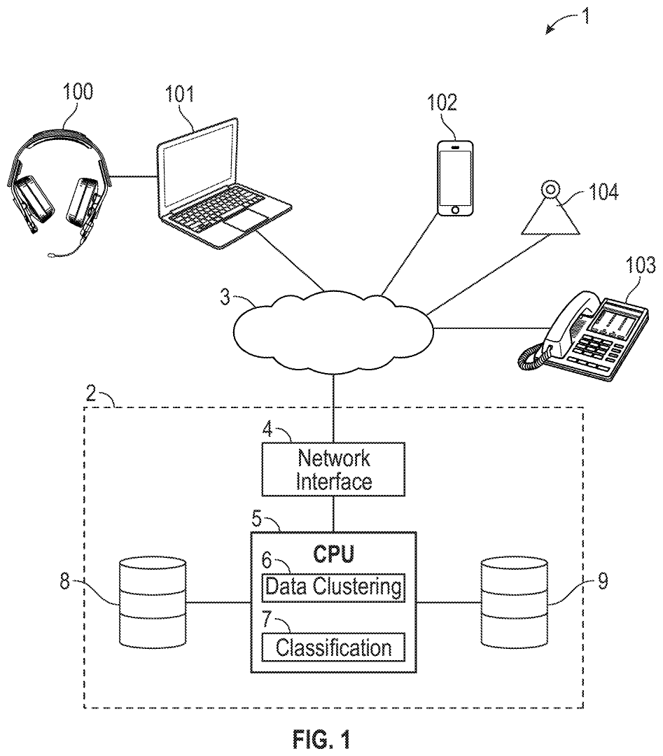

FIG. 1 shows an embodiment of a system 1 for audio anomaly detection in a voice signal. The system comprises a multiple user audio devices 100-104, namely a headset 100, computer 101, smart phone 102, desk phone 103, and a video conferencing system 104. The user audio devices 100-103 are connected to a remote audio analysis subsystem 2 via a network 3. The network 3 may for example be a private Ethernet network or the Internet.

It is noted, that a user audio device in the context of this embodiment is understood as a device that is configured to acquire/capture a user's voice using a microphone and to provide a corresponding voice signal. While computer 101 in the embodiment of FIG. 1 is configured to forward the audio of headset 100 and thus does not capture a user's voice directly in the shown configuration, it is possible that the computer 101 is operated without the headset 100 using an internal microphone. Accordingly, the computer 101 is also considered a user audio device. In some embodiments, a different number of user audio devices 100-103 are present.

The remote audio analysis subsystem 2 allows to analyze a current voice signal, i.e., a voice signal, provided by one of the user audio devices 100-103, to determine in an automatic and unsupervised fashion, whether the respective user audio device 100-103 is in a normal operating mode or an anomalous operating mode. For example, the audio analysis subsystem 2 allows to differentiate a correct microphone positioning from an incorrect microphone positioning or a typical background noise level from an unusually high background noise level and thus adds insight to the user's audio, picked up by the microphone of the respective user audio device 100-103. To provide this functionality, the remote audio analysis subsystem 2 classifies if the voice signal is in the optimal range or not based on the past trends in the user's voice signal metadata. This enables for example call center managers or analysts and most UC enterprise IT users to know if there is a bad audio experience issue (low audibility, jitter etc.) of a user and what caused it.

The remote audio analysis subsystem 2 comprises a network interface 4 to communicate with the user audio devices 100-103 and a central monitoring server (not shown). The remote audio analysis subsystem 2 further comprises a computer 5 that provides management functions as well as the functionality of a data clustering processor 6 and a classification processor 7. In this embodiment, the functionality of the data clustering processor 6 and the classification processor 7 is provided by executing corresponding programming, stored in an internal memory (not shown) of the computer 5. Alternatively or additionally, it is possible to provide at least a part of the functionality of at least one of data clustering processor 6 and classification processor 7 by dedicated circuitry.

The remote audio analysis subsystem 2 further comprises a voice history database 8 and a voice model database 9. The aforementioned components of remote audio analysis subsystem 2 may be co-located, e.g., in one computing system, or provided as separate systems, such as a cloud service.

The voice history database 8 stores historic audio metadata of past voice signals of the user audio devices 100-103. In the present embodiment, the historic audio metadata comprises

a) TxLevel: The dBSpl (sound pressure) input level collected by a microphone of a user audio device 100-103 and processed by its DSP,

b) TxNoise: The dBSpl input noise level collected by a microphone of a user audio device 100-103 and processed by its DSP,

c) NearTalk: The time duration value in mill seconds when there was a signal from the transmit side of a DSP of a user audio device 100-103. A non-zero value in NearTalk indicates the user of the user audio device 100-103 was talking, and

d) DeviceID: A user audio device identifier or a user/device combination identifier if different users should use the same one of the user audio devices 100-103.

The aforementioned metadata is generated by each user audio device 100-103 in a predefined interval, such as every second, whenever the user audio device 100-103 is used and its respective microphone is active. In other words, a data point is generated every second.

The metadata may be transmitted by each user audio device 100-103 to the computer 5 for storage in the voice history database 8 over network 3. Alternatively, and in case a central monitoring server (not shown) is used to collect the metadata of each user audio device 100-103, such as in a call center environment, the metadata may be transmitted by the central monitoring server to the computer 5 and subsequently stored in the voice history database 8.

Once enough historic audio metadata is stored in voice history database 8, e.g., more than 2000 data points, cluster analysis is performed by data clustering processor 6 for each user audio device 100-103 or each user/device combination, respectively, depending on the system setup, namely on whether the system 1 is configured for different users using the same one of the user audio devices 100-103 or not. A user audio model is obtained from each cluster analysis.

In the following and for clarity, it is assumed that a single user uses each of the user audio devices 100-103, and that thus the DeviceID of the historic audio metadata comprises an identifier for each user audio device 100-103. In some embodiments however, that the system 1 alternatively is configured for user/device combinations.

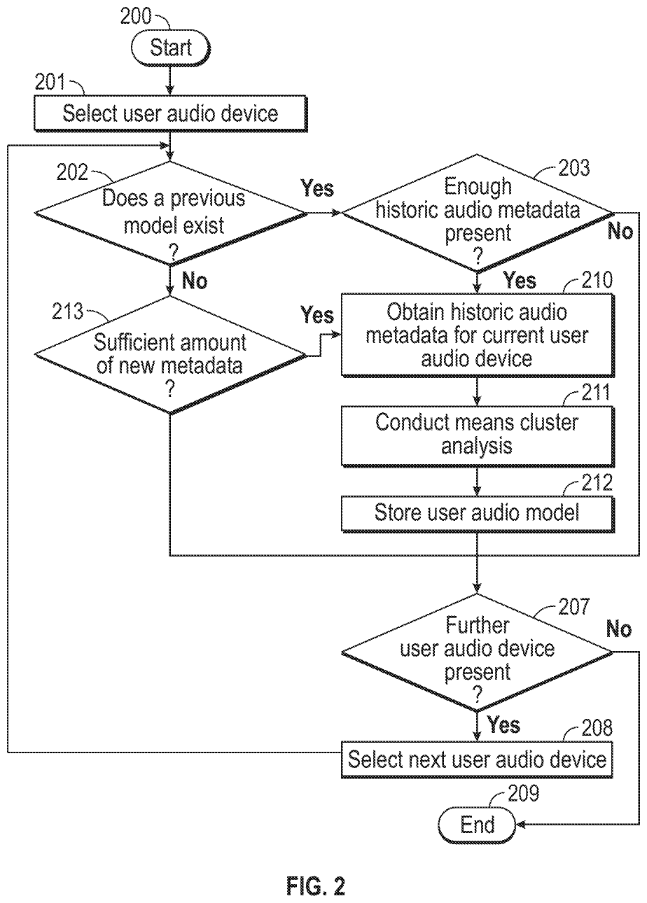

A schematic flow diagram of the operation of data clustering processor 6 is shown in FIG. 2.

The operation of data clustering processor 6 starts in step 200. The following operation may be conducted for example in regular intervals to initialize and update the user audio models. In step 201, a specific user audio device 100-103 is selected. This may simply be the user audio device 100 with the lowest DeviceID checksum, e.g. headset 100. In step 202, it is determined if the current run of the data clustering processor 6 is the first run or not, i.e., by checking, if a previous user audio model exists in voice model database 9. If this is not the case and in step 203, it is determined if already enough historic audio metadata exists in the voice history database 8, e.g., by checking, whether for the currently selected user audio device 100, at least 2000 data points are stored. If this is not the case, the operation continues with step 207 and it is checked, if a further user audio device 100-103 is present in the system. If this is the case, the next user audio device 100-103 is selected in step 208. Otherwise, the current run of the data clustering processor 6 is ended in step 209.

In case the voice history database 8 comprises 2000 or more data points for user audio device 100, the entire historic audio metadata of the device 100 is obtained from the voice history database 8 in step 210, i.e., the full dataset of all stored data points for the respective device 100. In step 211, K-means cluster analysis is conducted on the obtained historic audio metadata to partition the data into a normal operation cluster and an anomalous operation cluster, i.e., with K=2.

K-means clustering is a technique used to explore data when no pre-existent labels (typical audio range vs. anomaly range) are available for datasets. More formally, K-means clustering is a type of unsupervised learning from data, which is used when you have unlabeled data (i.e., data without defined categories or groups). The algorithm works iteratively to assign each data point to one of K groups based on the features that are provided.

When K-means clustering for fitting to two clusters, i.e., with K=2, is applied to a user device 100-103, the historic audio metadata dataset is broken down using two dimensions of data (e.g., in this embodiment, txLevel and nearTalk). The clusters show the mean magnitude of the user audio device 100-103 for each dimension (i.e., txLevel, nearTalk):

Anomalous operation cluster: The centroid for this cluster is where the txLevel is in the lower range and nearTalk is close to 0. This indicates that the user audio device 100 is not in mute, but the signal is very low.

Normal operation cluster: The centroid for this cluster is where the txLevel falls when the speaker is talking and nearTalk value is higher (nearTalk>0).

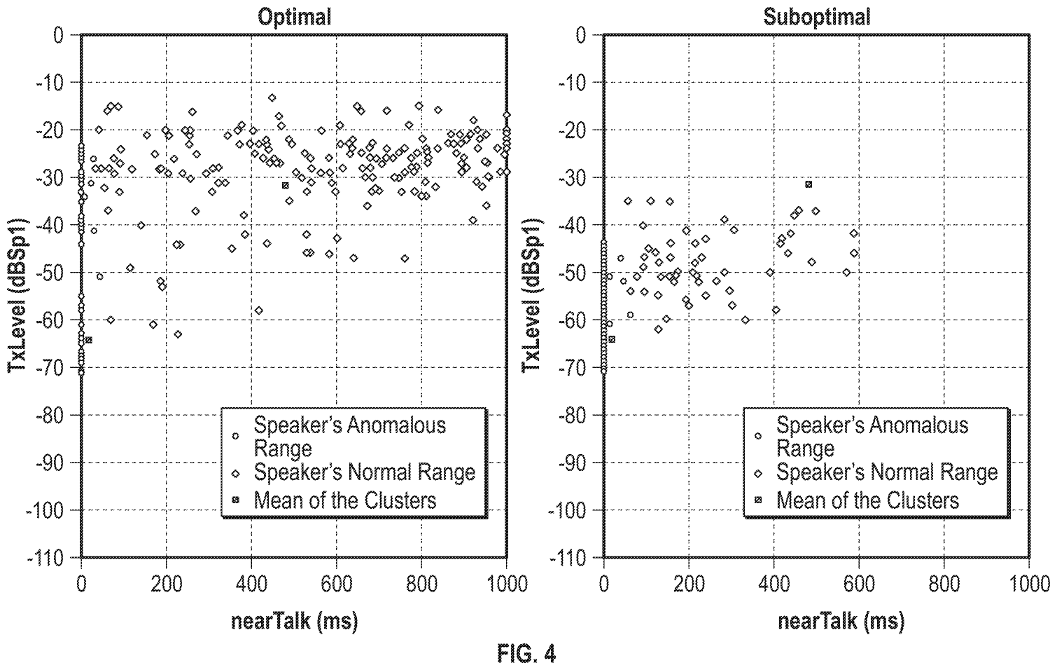

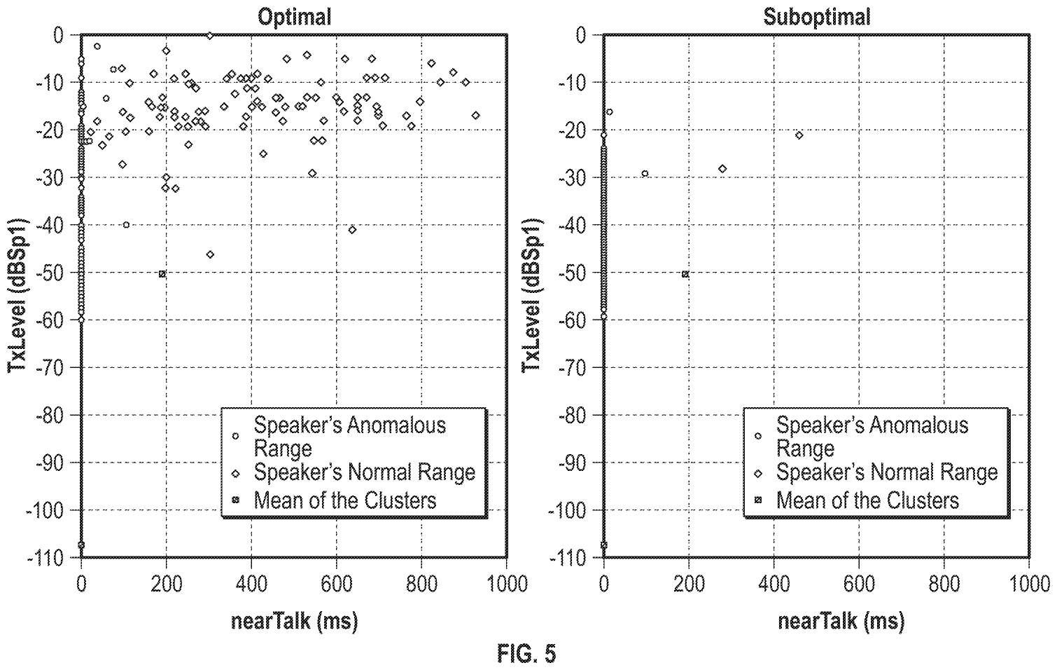

The results of the cluster analysis are shown by way of example in the diagrams of FIG. 4 for the current user audio device 100 and in FIG. 5 for a different user audio device 103. As can be seen, the results for the two user audio devices 100, 103 are significantly different. While the left side diagrams of FIGS. 4 and 5 show situations, where most of the data points are associated to the normal operation cluster, the right side diagrams show situations, where most of the data points are associated with the anomalous operation cluster.

For FIG. 4, the operation results in the following cluster data:

| Cluster Name | [symbol] (dbSpl) | [symbol] (ms) |
|---|---|---|
| Anomalous operation cluster | −64.197474 | 19.138958 |
| Normal operation cluster | −31.506727 | 479.747519 |

For FIG. 5, the operation results in the following cluster data:

| Cluster Name | [symbol] (dbSpl) | [symbol] (ms) |
|---|---|---|
| Anomalous operation cluster | −107.665356 | 0.000000 |
| Normal operation cluster | −50.235663 | 189.247772 |

Reverting back to FIG. 2, once the historic audio metadata is clustered in step 211, the resulting clustered data is stored as the user audio model of the user audio device 100 in voice model database in step 212. Operation is then continued with step 207, as discussed in the preceding.

The discussed operation of data clustering processor 6 is repeated in regular intervals, such as every day. In case a user audio model has already been established for a user audio device 100-103, a new model is created once a sufficient amount of new historic audio metadata is stored in voice history database 8. For example, if in the time since the last user audio model was created, further 500 data points have been added, the decision in step 213 will create a fresh user audio model and then overwrite the existing one in the voice model database 9. To allow this operation, each user audio model is stored in the voice model database 9 with information on which data points of the historic audio metadata served to form the user audio model. Alternatively, a simple counter may be used that indicates the last data point, used to generate the stored user audio model.

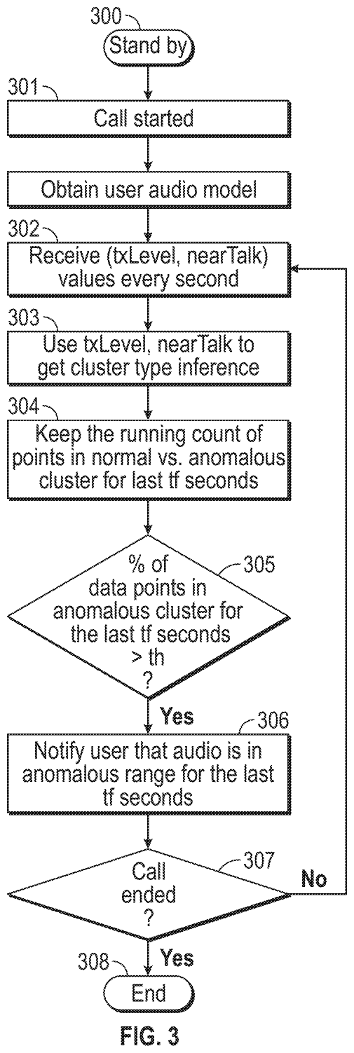

Once the user audio model for the current user audio device, i.e., headset 100, is stored in the voice model database 9, it is possible to for the classification processor 7 to analyze current audio metadata of a voice signal, received from the headset 100 in real-time. The operation of classification processor 7 is shown in the schematic flow diagram of FIG. 3.

If the system 1 is operational, classification processor 7 is in standby. When the user of headset 100 enables the headset 100, such as to place a call, a ‘call started’ event notification is provided to classification processor 7 in step 300. The classification processor 7 then obtains the user audio model from the voice model database 9 that is associated to the headset 100 in step 302. The headset 100 provides current or real-time audio metadata every second, namely in this embodiment txLevel and nearTalk. The current data point is used and compared with the user audio model to determine, which cluster is the data point is associated to by a distance measurement to the respective centroid of the normal operation cluster and the anomalous operation cluster. The result is stored in a buffer for a predefined running window period tf, e.g., 30 seconds in step 304.

In step 305, the percentage of data points in the anomalous cluster in the predefined running window period is determined and compared with a predefined threshold th, e.g., 50% percent.

If the threshold is met and in step 306, the user is informed by a corresponding message, transmitted and shown on computer 101, that the audio quality is anomalous. This allows the user to take countermeasures, e.g., if the microphone positioning is bad, to improve the positioning.

The operation of classification processor 7 is continued until the determination in step 308 provides that the call has ended. Then, the operation ends in step 308.

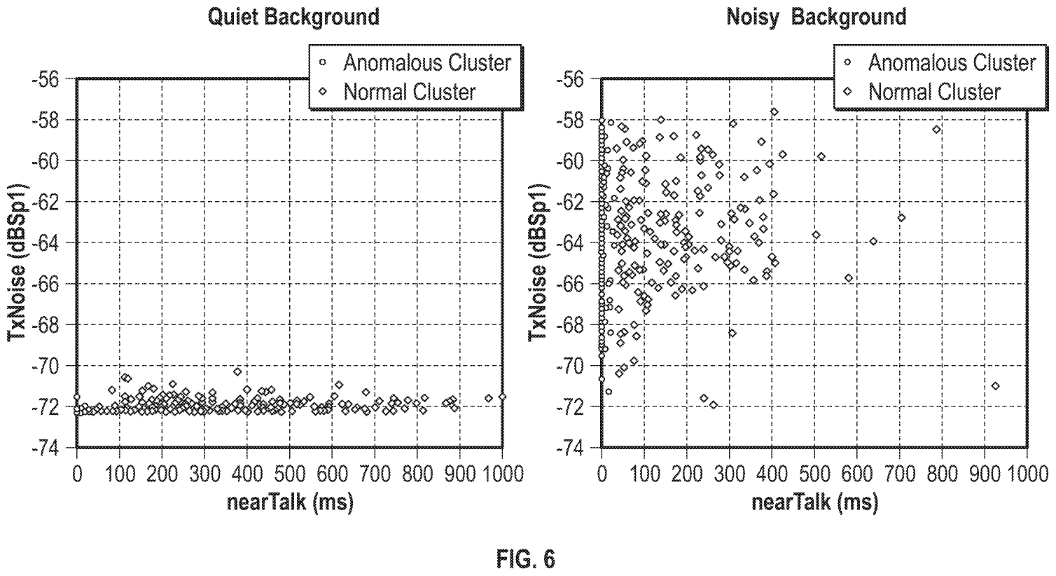

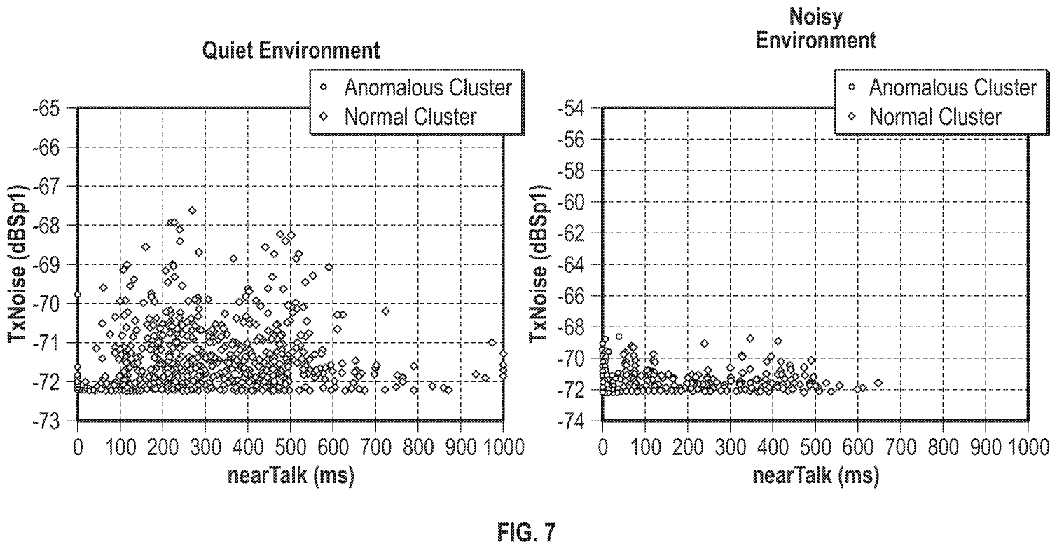

FIGS. 6 and 7 correspond to FIGS. 4 and 5 and show the results of the cluster analysis by way of example when in an embodiment instead of the txLevel data, as described in the preceding, TxNoise data is used for the cluster analysis and the subsequent processing of classification processor 7. The operation corresponds to what was described previously. However, in this case, the determination of a normal operating mode or an anomalous operating mode of the classification processor 7 provides an indication of whether the user was exposed to a high background noise level. Both analysis may be conducted simultaneously, using two user audio models, i.e., a “voice level user audio model” and a “noise level audio model” in corresponding embodiments.

For FIG. 6, the operation results in the following cluster data:

| Feature | Min | | Max |
|---|---|---|---|
| txNoise | −72.246094 | | −54.734375 |
| nearTalk | 0 | | 1000 |
| | Anomalous | Normal | Ratio |
| Cluster | Cluster | Cluster | (Anomalous/Normal) |
| Number of points in | 209 | 358 | 0.584 |
| quiet environment | | | |
| Number of points in | 392 | 175 | 2.24 |
| noisy environment | | | |

For FIG. 7, the operation results in the following cluster data:

| Feature | Min | | Max |
|---|---|---|---|
| txNoise | −72.246094 | | −62.465 |
| nearTalk | 0 | | 1000 |
| | Anomalous | Normal | Ratio |
| Cluster | Cluster | Cluster | (Anomalous/Normal) |
| Number of points in | 385 | 752 | 0.512 |
| quiet environment | | | |
| Number of points in | 716 | 441 | 1.62 |
| noisy environment | | | |

As will be apparent, the user audio device of FIG. 6 is in a high-noise environment, while the user audio device of FIG. 7 is in a low-noise environment. Still, the system 1 provides a sufficient differentiation between a normal noise level, given the typical environmental noise levels, and an anomalous noise level.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit may fulfill the functions of several items recited in the claims.

The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

What is claimed is:

1. A system for audio anomaly detection in a voice signal, comprising
A voice history database, which voice history database comprises historic audio metadata of one or more past voice signals, acquired during operation of a user audio device;
a data clustering processor, connected to the voice history database and configured for cluster analysis of the historic audio metadata into at least a normal operation cluster and an anomalous operation cluster and to provide a user audio model therefrom;
a voice model database, configured to receive and to store the user audio model; and
a classification processor, connected with the voice model database and configured to
receive current audio metadata of the voice signal from the user audio device;
compare the current audio metadata with the user audio model; and to determine therefrom, if the voice signal corresponds to a normal operating mode or an anomalous operating mode of the user audio device.

2. The system of claim 1, wherein the classification processor provides an anomalous operation indicator in case the anomalous operating mode is determined.

3. The system of claim 1, wherein the classification processor is configured to determine, if a predefined percentage of data points of the current audio metadata in a predefined time period are related to the anomalous operation cluster and in this case, determine, that the voice signal corresponds to the anomalous operating mode.

4. The system of claim 1, wherein the anomalous operating mode corresponds to one or more of an incorrect placement of a microphone of the user audio device, a defect of the user audio device, and an irregular background noise level, captured by the microphone of the user audio device.

5. The system of claim 1, wherein the data clustering processor is configured for cluster analysis using centroid-based clustering.

6. The system of claim 1, wherein the data clustering processor is configured for cluster analysis using K-means clustering.

7. The system of claim 1, wherein the historic audio metadata and the current audio metadata comprises sound pressure level information.

8. The system of claim 1, wherein the historic audio metadata and the current audio metadata comprises sound pressure level information of one or more of speech and noise.

9. The system of claim 1, wherein the historic audio metadata and the current audio metadata comprises a voice activity parameter.

10. The system of claim 1, wherein the voice history database is connectable to the user audio device to receive audio metadata and wherein the voice history database is configured to store the received audio metadata as historic audio metadata.

11. The system of claim 1, wherein the current audio metadata of the voice signal from the user audio device is additionally provided to the voice history database to update the historic audio metadata.

12. The system of claim 1, wherein the data clustering processor is configured for repeated cluster analysis of the historic audio metadata and to provide an updated user audio model therefrom.

13. The system of claim 1, wherein the determination of the classification processor comprises determining a distance of the current audio metadata to the normal operation cluster and the anomalous operation cluster.

14. The system of claim 1, wherein the voice history database comprises historic audio metadata of one or more past voice signals, acquired during operation of at least a first user audio device and a second user audio device.

15. The system of claim 14, wherein the data clustering processor is configured for cluster analysis of the historic audio metadata of the first user audio device and the second user audio device.

16. The system of claim 15, wherein the data clustering processor is configured to provide separate user audio models for each of the first user audio device and the second user audio device.

17. The system of claim 1, wherein the user audio device is one or more of a headset, desk a phone, or a personal communication device.

18. A data clustering processor for use in a system for audio anomaly detection in a voice signal, which data clustering processor is connected to a voice history database having historic audio metadata; the data clustering processor being configured for cluster analysis of the historic audio metadata into at least a normal operation cluster and an anomalous operation cluster and to provide a user audio model therefrom.

19. A classification processor for use in a system for audio anomaly detection in a voice signal, configured to
receive a user audio model and current audio metadata of the voice signal from a user audio device;
compare the current audio metadata with the user audio model; and to
determine therefrom, if the voice signal corresponds to a normal operating mode or an anomalous operating mode of the user audio device.

20. A method of audio anomaly detection in a voice signal, comprising
receiving a user audio model and current audio metadata of the voice signal;
comparing the current audio metadata with the user audio model; and to determine therefrom, if the voice signal corresponds to a normal operating mode or an anomalous operating mode of the user audio device.

21. A non-transitory computer-readable medium including contents that are configured to cause a processing device to conduct the method of claim 20.

22. A method of generating a user audio model for use in a system for audio anomaly detection in a voice signal, comprising
conducting cluster analysis of historic audio metadata of one or more past voice signals, acquired during operation of a user audio device, into at least a normal operation cluster and an anomalous operation cluster, and
generating a user audio model therefrom.

23. A non-transitory computer-readable medium including contents that are configured to cause a processing device to conduct the method of claim 22.
